(19) United States
(12) Patent Application Publication
(10) Pub. No.: US 2010/0077885 A1
(43) Pub. Date: Apr. 1, 2010

(54) Arrangemmmment In Control Device of Work Machine

(75) Inventor: Toni Karvonen, Tampere (FI)

Correspondence Address: DRINKER BIDDLE & REATH (DC), 1500 K STREET, N.W., SUITE 1100, WASHINGTON, DC, 20005-1209, US

(73) Assignee: Sandvik Mining and Construction Oy, Tampere (FI)

(21) Appl. No.: 12/279,140

(22) PCT Filed: Feb. 8, 2007
(86) PCT No.: PCT/FI2007/050070

§ 371 Date: Nov. 2, 2009

(30) Foreign Application Priority Data
Feb. 14, 2006 (FI) 20065110

(51) Int. Cl. G05G 1/00; G05G 7/00; B08B 3/00

(52) U.S. Cl. 74/491; 134/34

(57) ABSTRACT

A method for removing impurities from a control device of a work machine and a control device. The control device (1) comprises a trackball (4), from which impurities are flushed away. Flushing medium and impurities collected below the trackball are led along a discharge channel outside the control device. The entry of impurities into a component space comprising electronics is prevented. The discharge channel has a collecting cup for collecting impurities and leading them by means of a hose to a connecting part that has a conical mating surface for receiving the hose.

### BACKGROUND OF THE INVENTION

The invention relates to a method for removing impurities from a control device of a work machine, the method comprising: flushing with a flushing medium impurities from a trackball on the control device, and directing the impurities and the flushing medium away from the trackball along at least one discharge channel.

The invention further relates to a control device of a work machine, comprising a casing with at least a cover portion and bottom portion and at least one component space, at least one trackball for generating control signals, means for supporting the trackball to the cover portion of the casing, and at least one discharge channel for directing impurities away from the trackball.

Work machines, such as rock drilling rigs, mine vehicles, excavators, and the like use control devices, and control elements in the control devices provide control commands to a control unit or directly to actuators controlling the functions of the work machine. A trackball has been found to be a good control element of a work machine. In comparison with other corresponding control devices, such as joystick controls and push-buttons, the trackball has the disadvantage that it cannot be made tight, and dirt and moisture will enter its structure and through it on into the casing of the control device. This causes malfunctions and failures. To solve the problem, a trackball has been developed whose control ball can be detached, after which impurities can be flushed away from the housing or corresponding support element of the control ball. Further, the trackball is equipped with a discharge channel, along which the flushing medium and impurities can be led away. A problem with the priorart solution is that impurities can enter the casing through the joint between the discharge channel and casing and, on the other hand, impurities can spread inside the casing due to the poor sealing of the discharge arrangement. Impurities and moisture can damage the electric devices in the control device and cause malfunctions.

### BRIEF DESCRIPTION OF THE INVENTION

It is an object of the present invention to provide a novel and improved arrangement in the control device of a work machine.

The method of the invention is characterised by isolating connection from the trackball and discharge channel to the component space comprising electronics of the control device, directing the impurities along the discharge channel to a discharge opening on the outer surface of the casing of the control device, and sealing the discharge channel to the discharge opening in the casing of the control device.

The control device of the invention is characterised in that the trackball and discharge channel are isolated from the component space comprising electronics of the control device, the discharge channel is connected to a discharge opening, and the discharge channel is sealed to the discharge opening in the casing.

The idea of the invention is that the entry of impurities to the component space containing electronics of the control device is prevented from the trackball and discharge channel.

The invention provides the advantage that impurities and flushing medium can be led away from the control device in a controlled manner without the danger of their entry into the component space that contains electronics and possibly other sensitive components. When the electronics space remains clean and dry, malfunctions can be avoided.

The idea of an embodiment of the invention is that the outer surface of the control device has a discharge opening and that a discharge channel is connected to the discharge opening. Impurities and flushing medium are led in a controlled manner from the trackball along the discharge channel to the discharge opening that is on the outer surface of the control device. This type of structure is simple and does not require any special arrangements for positioning drain channels and hoses outside the control device.

The idea of an embodiment of the invention is that the discharge channel and opening are parts of the structure of the trackball. The bottom surface of the support element of the trackball can then extend to the outer surface of the control device. An opening in the support element can serve as the discharge channel and opening. This solution is well suited for situations, in which the control device is, at least at the trackball, shallow in depth. This type of trackball can be arranged into a projecting portion that is isolated from the actual component space. The projecting portion can be against the side surface of the casing.

The idea of an embodiment of the invention is that the control device comprises a collecting cup below the trackball. The collecting cup is arranged to seal the space below the trackball. The bottom of the collecting cup has a discharge opening that is connected to a discharge channel. The cup then collects any impurities and flushing medium that have entered underneath the trackball and leads them to the discharge channel. Such a separate collecting cup is simple to make. Arranging the cup in the space below the trackball is also simple and quick.

The idea of an embodiment of the invention is that the bottom of the casing has a discharge opening that is open to the outer surface of the casing and on the casing side thereof, there is a connecting part that opens to the top and has conical mating surfaces.

The idea of an embodiment of the invention is that a separate hose is connected to the bottom of the collecting cup. The bottom end of the hose is arranged to the connecting part, whereby the outer surface of the bottom end of the hose is substantially tightly against the conical mating surfaces of the connecting part. The hose and the connecting part seal against each other when the hose is arranged against the conical surfaces. No separate fastening elements are necessary herein. The cup and hose can be fastened as parts of the cover portion of the casing, and when the cover portion is installed in place, the second end of the hose pushes into the connecting part. This facilitates substantially the assembly of the control device and maintenance procedures.

The idea of an embodiment of the invention is that the hose, pipe, or corresponding channel connected to the collecting cup is arranged through the connecting part and thus extends to the outer surface of the casing.

The idea of an embodiment of the invention is that the collecting cup has a downward directed pipe-like section whose bottom part is arranged substantially tightly to the connecting part in the casing.

The idea of an embodiment of the invention is that the connecting part comprises an upward directed pipe-like section that is arranged to extend to the bottom of the collecting cup and to form a substantially tight joint.

The idea of an embodiment of the invention is that at least one of the connecting part and collecting cup bottom is equipped with a conical mating surface for connecting the connecting part and a funnel to each other substantially tightly. No separate sealing means are then needed to make a tight joint between the components to be connected.

The idea of an embodiment of the invention is that the collecting cup converges conically towards the discharge opening. The cup then directs the collected impurities efficiently to the discharge opening and on to the discharge channel.

The idea of an embodiment of the invention is that the bottom of the control device has a downward converging inner surface and a discharge opening at the trackball. The flushing water and impurities then flow from the trackball to the bottom of the casing and on along the oblique surface to the discharge opening that opens to the outer surface of the casing.

The idea of an embodiment of the invention is that the control device has one or more component spaces containing electronics and one or more component spaces containing a trackball. The spaces are separated from each other with at least one substantially tight partition, and the impurities and flushing medium is prevented from entering the electronics section.

### BRIEF DESCRIPTION OF THE FIGURES

Some embodiments of the invention will be described in greater detail by means of the attached drawings, in which

FIG. 1 is a schematic top view of a control device of a work machine,

FIG. 2 is a schematic sectional view of a part of a control device,

FIG. 3 is a schematic sectional view of an arrangement in which a collecting cup below a trackball is connected to a tubular connecting part at the bottom of a casing,

FIG. 4 is a schematic sectional view of an arrangement in which a collecting cup below a trackball comprises a tubular section that extends until a connecting part in a casing,

FIG. 5 is a side view of a control device in which a trackball is arranged in a projecting section,

FIG. 6 is a side view of a control device in which a trackball is arranged in a component space isolated from an electronics part, and

FIG. 7 is a schematic sectional view of another arrangement in which a hose or the like connected to a collecting cup below a trackball is arranged through a connecting part at the bottom of a casing.

For the sake of clarity, the figures show some embodiments of the invention in a simplified manner. Similar parts are marked with the same reference numbers in the figures.

### DETAILED DESCRIPTION OF SOME EMBODIMENTS OF THE INVENTION

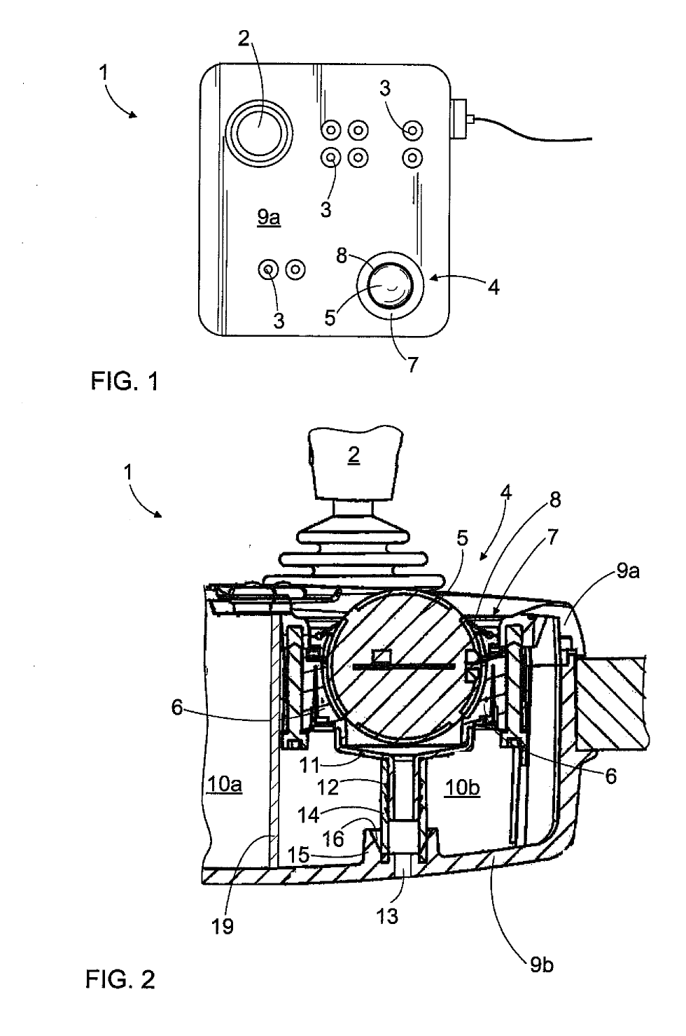

FIG. 1 shows a control device 1 of a work machine, which can comprise one or more joystick controls 2, push buttons 3 and trackballs 4 that the operator uses to give control signals to control the operation of the work machine. The control signals can be transmitted over a data communications connection to a control unit or directly to an actuator.

FIG. 2 shows a possible structure of a trackball 4. The trackball 4 comprises a control ball 5 that can be moved in different directions on its support element 6. The support element 6 can comprise an opening whose edges can be made curved in accordance with the outer surface shape of the control ball 5. The support element 6 can comprise sensors or the like for detecting the movements of the control ball 5 and for transforming them into electric signals. Further, the control ball 5 can be supported from the top with a fastening ring 7 that can comprise sealings 8 between the control ball 5 and fastening ring 7. The control ball 5 can extend below the bottom surface of the support element 6. When the fastening ring 7 is detached, the control ball 5 can be removed, in which case only the support element 6 of the trackball 4 remains in the control device 1. The support element 6 can be fastened to a cover portion 9a of a casing 9 of the control device 1. The cover portion 9a and a bottom portion 9b of the casing 9 define a component space 10 of the control device, into which necessary electric and mechanical switches and other components are positioned. The bottom portion 9b of the casing can be supported to the work machine. The cover portion 9a of the casing can in turn be easily opened and detached.

There can be a collecting cup 11 below the trackball 4. The cup 11 can be a separate piece made of plastic by injection-moulding, for example. The cup 11 can be a funnel-shaped piece, or at least its bottom can converge from top to bottom. The top part of the cup 11 can be arranged substantially tightly to a mating surface on the bottom surface of the support element 6. The cup 11 and mating surface of the support element 6 can be partially within each other. Further, the bottom part of the cup 11 can have a tubular section 12 that extends a distance toward a discharge opening 13 at the bottom portion 9b of the casing. A hose 14 can be arranged between the tubular section 12 and discharge opening 13. A first end of the hose 14 can be arranged around the tubular section 12 and a second end of the hose 14 can be arranged substantially tightly to a connecting part 15 connected to the discharge opening 13. The connecting part 15 can be a projecting portion that is formed inside the bottom portion 9b of the casing and can comprise conical mating surfaces 16 that converge toward the discharge opening 13. The outer surface of the second end of the hose 14 can press substantially tightly against the conical mating surface 16 of the connecting part 15. The hose 14 can be made of an elastic material, such as silicone or the like, that tightens well against the mating surface 16. Further, the tubular section 12 of the cup 11 can have shoulders, protrusions or the like that improve the sealing between the hose 14 and cup 11 and ensure the fastening of the hose 14 without any hose clamps or corresponding fastening elements. The length of the hose 14 can also in advance be dimensioned to be slightly, for instance 1 to 2 mm, longer than the distance between the cup 11 and connecting part 15 would require. Then, when the cover portion 9a is fitted in place, compression force is generated to press the outer surface of the second end of the hose 14 tightly against the mating surface 16.

When the cover portion 9a of the control device 1 is fitted in place, the second end of the hose 14 simultaneously settles automatically against the mating surface 16 of the connecting part 15. The connection of components related to water removal thus does not need to be considered when detaching and fastening the cover portion 9a, which naturally facilitates the assembly and maintenance.

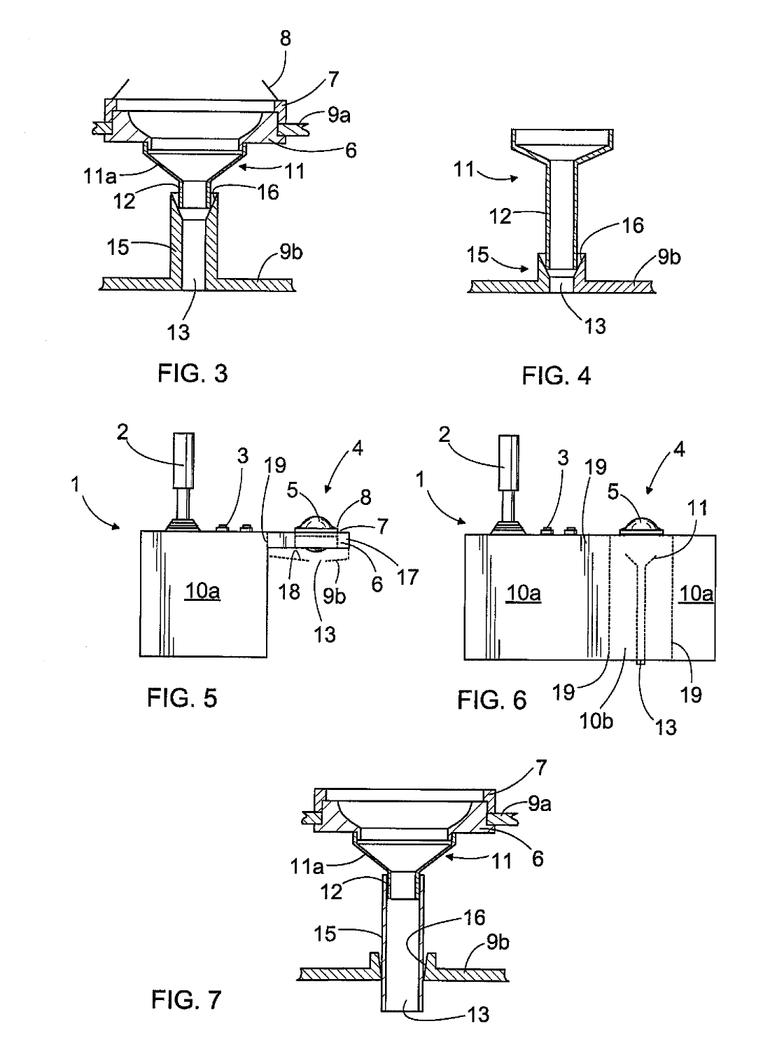

FIG. 3 shows the principle of a second embodiment. For the sake of clarity, the control ball 5 is not shown in the figure. The bottom of the collecting cup 11 can have a relatively short tubular section 12, the bottom outer surface of which can be arranged directly against the conical mating surface 16 of the connecting part 15. The cup 11 or at least its tubular section 12 can be made of an at least somewhat elastic material. The connecting part 15 can be a tubular projection that extends from the inner surface of the bottom portion 9b toward the cup 11. A separate hose between the cup 11 and connecting part 15 is then not needed. It is also possible that the mating surface 16 of the connecting part 15 is arranged against the conical outer surface 11a of the collecting cup 11, in which case the collecting cup 11 need not necessarily have a tubular section 12 and, on the other hand, the mating surface 16 of the connecting part 15 need not be conical.

FIG. 4 shows the principle of a third embodiment. For the sake of clarity, the figures only show the parts related to removing impurities. The bottom of the collecting cup 11 can have a relatively long tubular section 12, the bottom outer surface of which can be arranged against the conical mating surface 16 of the connecting part 15. The cup 11 or at least its tubular section 12 can be made of an at least somewhat elastic material. This type of structure is very simple to make and assemble.

It is also possible that the connecting part 15 is a separate piece that can be arranged on the inner surface of the bottom portion 9b of the casing at the discharge opening 13 and that can be fastened with shapelocking or gluing, for instance. The separate connecting part 15 can be made of an elastic material.

In FIG. 2, the collecting cup 11, the tubular portion 12 of the cup, the hose 14, and the connecting part 13 form the discharge channel. In FIGS. 3 and 4, the discharge channel can comprise a collecting cup 11, tubular portion 12, and connecting part 13.

FIG. 5 shows the principle of a fourth embodiment. The control device 1 can comprise a projecting portion 17 into which the trackball 4 is arranged. The projecting portion 17 can be essentially smaller in depth than the rest of the control device 1, since there is no need for an actual component space 10 in the projecting portion 17 but it is enough that at least the support element 6 of the trackball 4 can be fastened to it. The depth of the projecting portion 17 can be smaller than the diameter of the control ball 5, and thus the control ball 5 can also be partially visible on the bottom surface side of the control device 1. In this embodiment, the structure of the trackball 4 in itself comprises a discharge channel and opening 13.

Alternatively, at the projecting portion 17, the bottom portion 9b of the casing can totally cover the control ball 5 on the bottom surface side of the control device 1 with the exception of the discharge opening 13 of the bottom portion 9b that can be located at the trackball 4. The inner surface 18 of the bottom portion 9b can be made to converge toward the discharge opening, in which case fluid that has entered the projecting portion 17 will flow naturally toward the discharge opening and out of the control device 1. Thus, this embodiment does not necessarily need a collecting cup, hose, or connecting part. This type of drain system can be arranged to component spaces whose space is separated with a partition 19, for instance, from moisture-sensitive components, or in which the trackball is the only component. Fluid flowing down to the bottom of the component space does, therefore, not cause any problems.

FIG. 6 shows a control device 1 in which the component space 10b comprising a trackball 4 is isolated with partitions 19 from other component spaces 10a comprising electronics, for instance. The entry of impurities, moisture, and flushing medium into the component space 10a is thus prevented from the component space 10b comprising the trackball. The drain system can be one of the solutions described in connection with the previous figures. Further, for the sake of safety, a partition 19 can be arranged between the component spaces 10a, 10b, even though the drain system is tightly connected to the trackball 4 and the discharge channel is carefully sealed to the casing. An example of this is shown in FIG. 2.

FIG. 7 shows yet another embodiment in which the hose 12 or a corresponding pipe serving as the discharge channel is arranged through the connecting part 15 so that its outermost end extends outside the casing. The outer surface of the hose 12 or corresponding discharge channel then seals against the conical mating surfaces 16 of the connecting part 15. It is also possible to arrange a fixed tubular portion on an extension of the collecting cup 11 to extend through the connecting part 15.

In some cases, the features described in this application can be used as such, regardless of other features. On the other hand, the features presented in this application can, if necessary, be combined to form various combinations.

The drawings and the related description are only intended to illustrate the idea of the invention. The invention may vary in detail within the scope of the claims.

1. A method for removing impurities from a control device of a work machine, the method comprising:
flushing with a flushing medium impurities from a trackball on the control device;
directing the impurities and flushing medium away from the trackball along at least one discharge channel;
isolating connection from the trackball and discharge channel to a component space comprising electronics of the control device;
directing the impurities along the discharge channel to a discharge opening on the outer surface of the casing of the control device; and
sealing the discharge channel to the discharge opening in the casing of the control device.

2. A method as claimed in claim 1, comprising sealing the discharge channel to at least one conical mating surface on the casing of the control device.

3. A method as claimed in claim 1, comprising
sealing the discharge channel to at least one conical mating surface on the casing of the control device,
collecting the impurities into a collecting cup arranged tightly below the trackball, and
leading the impurities outside the casing by means of a hose connected to the collecting cup.

4. A method as claimed in claim 1, comprising arranging between the component space comprising electronics and a component space comprising the trackball additionally at least one partition that prevents the entry of impurities from the trackball to the electronics space.

5. A control device of a work machine, which comprises:
a casing having at least a cover portion and a bottom portion and at least one component space;
at least one trackball for generating control signals;
means for supporting the trackball to the cover portion of the casing; and
at least one discharge channel for leading impurities away from the trackball,
wherein the trackball and discharge channel are isolated from the component space comprising electronics of the control device,
the outer surface of the casing of the control device has a discharge opening,
the discharge channel is connected to the discharge opening, and
the discharge channel is sealed to the discharge opening in the casing.

6. A control device as claimed in claim 5, wherein
the control device comprises a collecting cup below the trackball,
the collecting cup is arranged to seal the space below the trackball, and
the bottom of the collecting cup has an opening connected to the discharge channel.

7. A control device as claimed in claim 5, wherein
the control device comprises a collecting cup below the trackball,
the collecting cup is arranged to seal the space below the trackball,
the bottom of the collecting cup has an opening connected to the discharge channel,
the bottom portion of the casing has a discharge opening that opens to the outer surface of the casing,
inside the casing, at the discharge opening, there is an upward opening connecting part having a conical mating surface,
a separate hose is connected to the bottom of the collecting cup, and the bottom end of the hose is arranged to the connecting part, whereby the outer surface of the bottom end of the hose is substantially tightly against the conical mating surface of the connecting part.

8. A control device as claimed in claim 5, wherein characterised in that
the control device comprises a collecting cup below the trackball,
the collecting cup is arranged to seal the space below the trackball,
the bottom of the collecting cup has an opening connected to the discharge channel,
the bottom portion of the casing has a discharge opening that opens to the outer surface of the casing,
inside the casing, at the discharge opening, there is an upward opening connecting part having a conical mating surface,
a separate hose is connected to the bottom of the collecting cup,
the bottom end of the hose is arranged to the connecting part, whereby the outer surface of the bottom end of the hose is substantially tightly against the conical mating surface of the connecting part, and
the hose is arranged through the connecting part and thus extends to the outer surface of the casing.

9. A control device as claimed in claim 5, wherein
the control device comprises a collecting cup below the trackball,
the collecting cup is arranged to seal the space below the trackball,
and the bottom of the collecting cup has an opening connected to the discharge channel,
the bottom portion of the casing has a discharge opening that opens to the outer surface of the casing,
inside the casing, at the discharge opening, there is an upward opening connecting part, and
the collecting cup has a downward directed tubular section whose bottom part is arranged substantially tightly to the connecting part.

10. A control device as claimed in claim 5, wherein
the bottom portion of the casing has a discharge opening that opens to the outer surface of the casing,
inside the casing, at the discharge opening, there is a connecting part,
the connecting part comprises an upward directed tubular section that is arranged to extend to the bottom part of the collecting cup, and
at least one of the connecting part and bottom part of the collecting cup is equipped with a conical mating surface for connecting the connecting part and collecting cup substantially tightly to each other.

11. A control device as claimed in claim 5, wherein
the control device comprises a collecting cup below the trackball,
the collecting cup is arranged to seal the space below the trackball,
the bottom of the collecting cup has an opening connected to the discharge channel, and
the bottom of at least the collecting cup is conical and converges toward the opening of the collecting cup.

12. A control device as claimed in claim 5, wherein
the control device comprises a collecting cup below the trackball,
the collecting cup is arranged to seal the space below the trackball,
the bottom of the collecting cup has an opening connected to the discharge channel,
between the collecting cup and connecting part, there is a hose that is made of an elastic material, and
the hose is made longer than the distance between the collecting cup and connecting part requires, whereby setting the cover portion of the control device in place against the bottom portion is arranged to compress the hose and to generate a compression force that is arranged to press the hose against the conical mating surface in the connecting part.

13. A control device as claimed in claim 5, wherein the control device has at least one component space comprising electronics and at least one component space comprising a trackball, which are additionally separated from each other with at least one substantially tight partition.
